(19) United States
(12) Patent Application Publication
(10) Pub. No.: US 2022/0036433 A1
(43) Pub. Date: Feb. 3, 2022

(54) Shared Virtual Shopping Basket

(71) Applicant: Confer With Limited, London (GB)

(72) Inventors: Serge Martin Line Milbank, London (GB); Daniel John Garner, London (GB)

(21) Appl. No.: 17/444,057

(22) Filed: Jul. 30, 2021

Related U.S. Application Data
(60) Provisional application No. 62/706,109, filed on Jul. 31, 2020.

(51) Int. Cl. G06Q 30/06

(52) U.S. Cl. CPC G06Q 30/0633

(57) ABSTRACT

Methods and apparatus, including computer program products, for collaborative online shopping between a customer and a retailer representative. A communication channel is provided through which communication channel the customer and representative discuss items available for purchase on a retailer website. The communication channel can accommodate different communication modalities for the customer and the representative. A shared virtual shopping basket is provided, for adding or removing items by the customer or representative. The basket is synchronously shared between, and viewable by, the customer and representative. When the customer or the representative adds, removes or changes an item, the basket is updated to reflect the changes, and a notification is sent to the customer and/or representative about the updates to the basket. When shopping is complete, the contents is transferred to a shopping cart at the retailer website to complete the purchase.

### BACKGROUND

The present invention relates to computer-based shopping, and more specifically, to methods and systems for collaborative shopping between a customer and a retailer representative.

Shopping is currently done in very discrete fashions, such as in a physical retail store, or online, and there is typically very little or no overlap between the two. There are some solutions in which several customers may shop together online and share a shopping basket. Typically, when shopping is done online, there is no interaction between the retailer and the consumers, and the consumers must rely on product descriptions from the retailers' websites and/or reviews from other consumers, either on the retailers' websites or on independent review websites.

When shopping online, the website for the online store typically has a shopping basket. The consumer selects the items that she or he wants to buy from the website and adds the items to the shopping basket. When the consumer is done shopping, he or she checks out, pays for the items, and enters a shipping address, etc. to have the items delivered to their residence or some other specified location.

### SUMMARY OF THE INVENTION

In general, in one aspect, the various embodiments of the invention provide methods and systems, including computer program products, for collaborative online shopping between a customer and a retailer representative. A communication channel is provided between the customer and the retailer representative, through which communication channel the customer and retailer representative can have a dialog with respect to items available for purchase on a retailer website. The communication channel is configurable to accommodate different communication modalities for the customer and the retailer representative. A shared virtual shopping basket is provided, into which items can be added or removed in response to instructions from either the customer or the retailer representative. The shared virtual shopping basket is synchronously shared between the customer and retailer representative and is synchronously viewable by the customer and the retailer representative. In response to the customer or the retailer representative performing adding, removing or changing features of an item in shared virtual shopping basket, the shared virtual shopping basket is updated to reflect the changes that were made to the item, and/or a notification is sent to the customer and/or retailer representative about the updates that were made to the shared virtual shopping basket. In response to the customer or retailer representative indicating that shopping is complete, the contents of the shared virtual shopping basket is transferred to a shopping cart at the retailer website to complete the purchase at the retailer website.

The various embodiments of the invention can include one or more of the following features. The communication channel can be independent and agnostic from the shared virtual shopping basket. The communication modalities include third party communication, video communication, voice communication, augmented reality, or virtual reality. The shared virtual shopping basket can be implemented as a microservice and can have a number of application programming interfaces allowing customers and retailer representatives to access the items in the shared virtual shopping basket. The communication channel can be configured to be populated with a real-time product feed showing items from the retailer's website. The notifying can be done using a publish-subscribe mechanism relating to changes made to the shared virtual shopping basket.

The details of one or more embodiments of the invention are set forth in the accompanying drawings and the description below. Other features and advantages of the various embodiments of the invention will be apparent from the description and drawings, and from the claims.

### BRIEF DESCRIPTION OF THE DRAWINGS

FIG. 1 shows a process for collaborative online shopping between a customer and a retailer representative, in accordance with one embodiment.

FIG. 2 shows schematic block diagram of a system for collaborative online shopping between a customer and a retailer representative, in accordance with one embodiment.

FIG. 3 shows a schematic view of a publish/subscribe model of collaborative online shopping between a customer and a retailer representative, in accordance with one embodiment.

Like reference symbols in the various drawings indicate like elements.

### DETAILED DESCRIPTION

The various embodiments of the invention pertain to systems, methods and computer program products for collaborative shopping between a customer and a retailer representative, using a shared virtual shopping basket. Both the retailer representative and the customer can add items into the shared virtual shopping basket, or remove items from the shared virtual shopping basket. In contrast to existing solutions, the shared virtual shopping basket in accordance with the various embodiments described herein is not replicated between several users. Further, the shared virtual shopping basket is shared in a synchronous manner between a customer and a retailer representative, allowing the customer to benefit from the retailer representative's knowledge and advice when selecting items to purchase. As such, it more closely resembles an in-person shopping experience, compared to a setup where an online shopping basket is merely replicated on several users' computers and each user can add items to the shopping basket.

The various embodiments of the invention create an immersive retail shopping platform, which bridges the gap between the physical and virtual retail worlds. The overall principle of the various embodiments of the inventive platform is to bring the retailer closer to their customers in an online setting, so the retailer's representatives can assist the customers as if the customers were in the physical store. The platform in accordance with the various embodiments of the invention serves as an add-on that augments a retailer's conventional ecommerce platform, allowing the retailer and their associated product experts or agents (also referred to herein as “retailer representatives”) to engage, through various types of communication channels (e.g., voice, video, augmented reality, virtual reality, third party communications, such as various types social channels, etc.) on a one-to-one basis with their customers. The retailer representative can converse and interact with the customer over these channels, browse products from the retailer as if the customer were in the physical retail store, and jointly manage the customer's shared virtual shopping basket (e.g. add, view, update, or delete items). It should be noted that different embodiments allow for different communication modalities for the retailer and customer representative while they are communicating with one another. For example, the customer may use text messages in her dialog with the retailer representative, while the retailer representative may respond by voice. Having this ability to accommodate different communication modalities allows for a wider range of devices to be used by the customer and retailer representative, respectively. It also allows for the communication to occur in a wide range of settings, for example, in situations where the customer may not be able (or want) to use voice/video communication for privacy or other reasons.

Both the retailer representative and the customer can view the same, real time, shared virtual shopping basket and can manage it together. Once the customer is satisfied with the items in the shared virtual shopping basket, they can choose to check out the basket to the retailer's website, at which time the retailer's conventional ecommerce shopping basket is populated with the items from the shared virtual shopping basket, and the customer can continue their shopping experience by checking out and paying for the items using the conventional checkout and payment mechanisms at the retailer's website. The shared virtual shopping basket has several key differences to a standard, online, website shopping basket. Some of these differences will now be described.

One difference is that both the retailer representative and the customer have joint, real-time control over the shared virtual shopping basket. That is, both parties are viewing the same basket, synchronously, on their respective devices. As both parties are conversing over synchronous, real time communication channels, it is beneficial to have a synchronous shared virtual shopping basket to avoid any unnecessary delays when changes are made to the basket. This single, shared, real time basket mimics, as closely as possible in the virtual world, a physical shopping basket within a physical store—e.g. a basket that both parties are managing and viewing. Both parties can add products into the shared virtual shopping basket in real time and view the changes instantly. Both parties can change the products(s) in the shared virtual shopping basket, e.g., product dimensions or quantity, and the basket will reflect the changes in line with the retailer's products and the basket value will automatically update. Both parties can remove products(s) from the basket and the basket value, and quantity will automatically update. Any device that is suitable for browsing websites can be used in accordance with the various embodiments described herein, such as computers, laptops, tablets, smartphones, etc.

As was described above, one key difference in this approach as compared to conventional solutions is that the retailer representative and the customer are both linked to a single real time, shared virtual shopping basket. Both the retailer representative and the customer can jointly manage the shared virtual shopping basket (add, view, update or remove items) as if it were a physical basket within a store. This ensures the closest likeness to an in-store experience, in contrast to some online shared shopping baskets, which are duplicated between customers for purposes of shopping together, and without any involvement by a retailer representative.

Another difference is that the shared virtual shopping basket is independent of the retailer's conventional website basket and communication channels, and runs on an independent platform. This allows presentation and management of the shared virtual shopping basket, regardless of the communication channel in which the retailer's representative and the customer are engaging. For example, the shared virtual shopping basket can be implemented as a separate microservice that is set up purely to manage the shared virtual shopping basket. The shared virtual shopping basket can seamlessly move between, and be rendered in, the relevant communication channel (e.g., webRTC, WhatsApp, or any similar communication channel), ensuring a consistent basket experience for the retailer representative and the customer. This provides for a scalable and future-proofed basket experience for the retailer, as the basket is independent of the communication channel. This flexibility allows for leveraging of the different capabilities of the communication channels and ensures a fully integrated and seamless shopping experience for both parties.

The contents of the shared virtual shopping basket can move between the shared virtual shopping basket and retailer's conventional website basket when required (typically, when the customer is ready to check out and complete their purchase with the retailer), by merging the items populated in the shared virtual shopping basket with the retailer's online basket. The exact mechanisms for how the transfer of the contents of the shared virtual shopping basket to the retailer's website basket is implemented will vary depending on which e-commerce platform is used by the retailer. In one embodiment, a microservice is set up for each e-commerce platform to effectuate the transfer, which will generally be done through a RESTful API call to the retailer's shopping site. However, it should be realized that other embodiments are also possible.

Yet another difference is that real time product feeds can be driven into the experience through a basket micro service. The basket micro service is designed to allow management of real time feeds of product data from a retailer's ecommerce platform, directly into the shared virtual shopping basket. This uses a combination of secure connectors (using either RESTful APIs, SOAP APIs, Message Queues or flat File Feeds, or any conventional e-commerce API) to allow connection to, reading and presenting the retailers real time product feeds into the communication channel and ultimately into their shared virtual shopping basket. The interface to the e-commerce platform returns either a JSON or XML payload which is rendered in real time and presented to the customer. This ensures that the latest information in the shared virtual shopping basket is identical to the information presented on the retailer's website, as all entities using the shared basket are being fed from the same source. That way, the products in the shared virtual shopping basket are always up to date and in line with the retailer's information (e.g. price, stock levels, availability etc.). This also facilitates the ability to introduce new immersive technologies such as Video, Augmented Reality, Voice, Rich Chat, etc., into the virtual shopping experience and provides a scalable architecture for leveraging the latest immersive technologies into a shopping experience, without introducing a technical integration barrier to the retailer. This type of e-commerce architecture, where the presentation layer for the user is decoupled from the application layer and where the two layers communicate through various APIs is commonly referred to as “Headless Commerce.”

In some embodiments, the customer can also give permission to a retailer representative to provide recommendations, offers, flash sales, and the like. In some embodiments, the customer can give permission to the retailer to automatically add items to the shared virtual shopping basket (e.g., in response to a customer accepting a “buy-one-get-two” offer, or the like), or to change items (e.g., substituting a certain item for an equivalent item that is on sale, etc.). Typically, both the retailer representative and the customer would be alerted when such changes occur to the shared virtual shopping basket. In some embodiments, there may also be an indicator for each item in the shared virtual shopping basket that lets the customer and retailer representative know who added the item to the shared virtual shopping basket. For example, all items added by a customer could be marked with a first color, all items added by the retailer representative could be marked by a second color, and all items added “automatically” could be marked by a third color. Many variations can be envisioned by those having ordinary skill in the art.

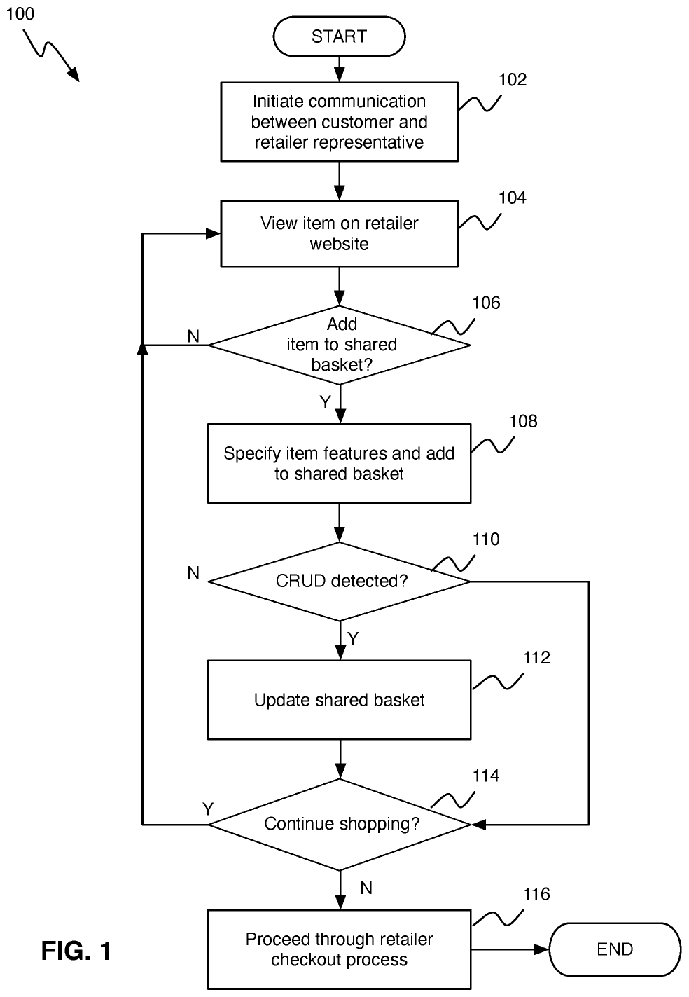

FIG. 1 shows an overview of a process 100 for populating and managing a shared virtual shopping basket, in accordance with one embodiment. As shown in FIG. 1, the process 100 starts by a customer initiating a call with the retailer representative (step 102). This can be done, for example, by either clicking a link sent to the customer via some communication channel (e.g. SMS, Email etc.) for an appointment, or by clicking an option on the retailer's website to engage with a retailer representative. Both of these trigger points initiate the immersive experience between the customer and the retailer representative.

Next, the customer views one or more items from the retailer's website (step 104). For example, the retailer representative can select products of interest for the customer and present those to the customer in the communication channel, through the platform. This is how the customer views an item when in dialogue with the retailer representative and can discuss the item with the retailer representative, prior to adding the item into the shared virtual shopping basket. The retailer representative views the same items as the customer and the chooses the relevant item to display to both parties. The items are dynamic and populated via a real time product feed from the retailer's website.

After viewing an item, a decision is made as to whether the item should be added to the shared virtual shopping basket (step 106). If customer is not interested in adding the item, the process goes back to step 104 and a new item is displayed to the customer. If the customer would like to add the item to the shared virtual shopping basket, the process continues to step 108, where item features are specified and the item is added to the shared virtual shopping basket. The item can be added to the shared virtual shopping basket either by the retailer representative or by the customer. The adding operation is orchestrated from the communication channel and takes the product, from product feed on the retailer's website and adds the item to the shared virtual shopping basket. The item features can include basic details such as quantity, size, color etc. are selected in the relevant communication channel of each party. These details are also fed from the retailer's product feed (Store Front API) and taxonomy and are completely dynamic. They allow either the customer or the retailer representative to select the correct item in the shared virtual shopping basket. After the item is selected and added to the shared virtual shopping basket, either party can view the contents of the shared virtual shopping basket, at the same time, in the relevant communication channel of each party.

As with any shopping experience, a customer may change their mind. Hence, the shared virtual shopping basket allows either party to mirror the in-store experience through:

Adding new items into the shared virtual shopping basket;

Reading/viewing the Item(s) in the shared virtual shopping basket;

Updating one or more item properties, by either party; or

Removing one or more items from the shared virtual shopping basket, by either party.

These operations are collectively referred to as CRUD (Create, Read, Update, Delete) operations. Thus in step 110, the process checks whether the customer or the retailer has performed any CRUD operations. If there has been one or more CRUD operations, the shared virtual shopping basket is updated in step 112, and if there has not been any CRUD operations, the process proceeds to step 114 where it is determined whether the customer would like to keep shopping. This determination can be made in a variety of ways, for example, through a dialog with the retailer representative, or by the customer clicking a link on the retailer's website, etc.

If the customer indicates that he would like to keep shopping, the process returns to step 104 and continues as outlined above. If the customer indicates that he is done shopping, the contents of the shared virtual shopping basket are copied into the retailer's conventional shopping basket on the retailer's website. The process for doing this varies based on the e-commerce platform that the retailer uses. However, this is generally performed by either a RESTful API call to the retailer's e-commerce platform or by using an embedded application inside the retailer's e-commerce platform (i.e., headless commerce). Once the items have been copied into the retailer's basket, the customer can proceed to check out on the retailer's website, pay for their items and then follow the normal order process for the retailer (step 116), which ends the process 100.

As noted above, the general concept of an online shopping basket is commonly seen with online retailers. However, directly connecting the retailer representative and customer in such a way that they both can synchronously manage a single shared virtual shopping basket, which is independent of the communication channel, are all new concepts. Further, this introduces a significantly scalable technology and bridges the gap between a retailer serving a customer in a physical store versus the virtual world.

It is important to note that the invention is not limited to a single shared virtual shopping basket. For example, in some embodiments, there may be several shared virtual shopping baskets, such that a customer may shop on behalf of someone (e.g., her elderly grandmother) and have one shared virtual shopping basket for herself and one shared virtual shopping basket for that other person, and the retailer representative can interact independently with each such basket, in the different ways described above. This one-to-many type of interaction can allow a single retailer representative interact with multiple customers on a “group call” where the retailer representative may present items to a smaller group of customers, and then interact individually with customers with respect to adding items to their respective shared virtual shopping baskets.

In yet other embodiments, a customer may “hand over” their shared virtual shopping basket to another customer. For example, a college student may do some clothes shopping from his dorm room, then hand the shared virtual shopping basket over to his father, who may be located in a different city and who adds a pair of socks for himself, and then has the pleasure of checking out and paying for the entire contents of the shared virtual shopping basket.

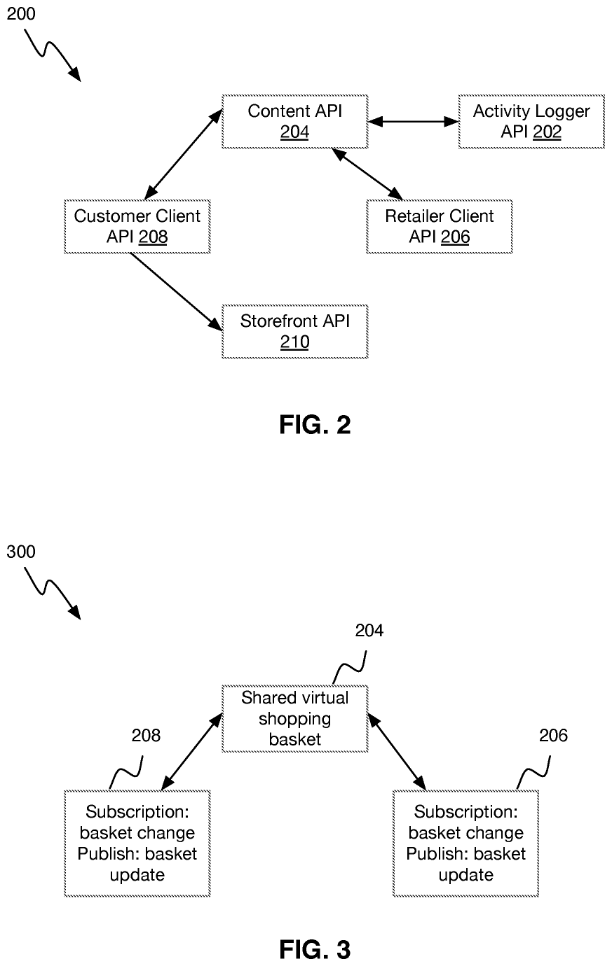

FIG. 2 shows a system 200 in accordance with one embodiment of the invention. As can be seen in FIG. 2, the system includes an Activity Logger API 202, a Content API 204, a retailer client API 206, a customer client API 208, and a storefront API 210. The Activity Logger API 202 is implemented as a microservice and manages all the activity that occurs between the customer, retailer representative, product feed, and so on, in order to create an audit trail from start to finish for all activity that occurs during the retail engagement between the customer and the retailer representative. The Activity Logger API 202 is module-independent and can store activity from any service.

The Content API 204 is an API that manages the shared virtual shopping basket and ensures that both the customer and the retailer representative synchronously view the same basket. Both the retailer client 206 and the customer client 208 can access the Content API 204 through the Publish/Subscribe method described above, allowing both the customer and the retailer representative to manage, in real time, the contents of their shared virtual shopping basket, as described above with reference to FIG. 1.

The Retailer Client API 206 hosts the retailer client on the platform, and provides mechanisms for the retailer representative to select products to send to the customer to view and to interact with the shared virtual shopping basket through the Content API 204. Conversely, the Customer Client API 208 hosts the customer client on the platform and provides mechanisms for the customer to view products shared by the retailer representative, and to interact with the shared virtual shopping basket through the Content API 204. As was mentioned above, a key point here is that the customer and the retailer representative can engage across a variety of communication channels and is not limited to a standard Web Real-Time Communication (webRTC) user interface. That is, the implementation shown in FIG. 2 is a channel agnostic (i.e., headless commerce) system.

Finally, the Storefront API 210 is the link to the retailer's online store and allows query, in real time, of the products to be populated into the shared virtual shopping basket and further allows merging items into the retailer's main shopping basket, as described above. The Storefront API 210 may contain several connectivity modules, such that seamless connection to retailer sites can be accomplished.

As discussed above, the customer and the retailer representative both have access to the shared virtual shopping basket, which is different and independent of the retailer website's basket, and the communication channel through which it is being managed. This shared virtual shopping basket is created under a temporary database through the Content API 204. Once the shared virtual shopping basket is created, the Content API 204 manages access to the shared virtual shopping basket and ensures that both the customer and the retailer representative, through the customer client API 208 and the retailer client API 206, respectively, view exactly the same shared virtual shopping basket in the channel of their choosing.

Either party can access, in the channel of their choice (e.g., a webRTC channel, RCS/Apple Business Chat etc.), the shared virtual shopping basket through the Publish/Subscribe Model. When these methods are executed from the respective channels, items are either added to or removed from the shared virtual shopping basket using the Content API 204. In some implementations, the shared virtual shopping basket is stateless, either at the customer or at the retailer representative side hence they are both viewing the same basket. The state of the shared virtual shopping basket is maintained by the content API 204. Items get fed into the content API 204, via an Admin API (not shown), and can then be added by the customer or the retailer representative to the shared virtual shopping basket.

Any change to the shared virtual shopping basket triggers a dirty request to the other side (synchronous update). Using a publish-subscribe mechanism, the change is being listened to by both parties' sides. Thus, either the retailer client API 206 or the Customer Client API 208 can make the dirty request. This allows N number of entities to read the same data at exactly the same time. Generally, when data is being read from a table in a database, the table is momentarily locked whilst it gets the answer. This ensures the data does not change during the actual read. A dirty read does not do this locking, which could mean the data may change whilst it is being read—hence a “dirty read.” This triggers an automatic update to whoever has subscribed and is listening. As a result, it can be ensured that both parties are looking at the latest version of the shared virtual shopping basket. Without the dirty read, there is a possibility that the database could be briefly locked as described above, which would result in two different answers being provided to the parties viewing the shared virtual shopping basket.

FIG. 3 schematically shows a publish/subscribe model 300 between the shared virtual shopping basket 204, the customer client API 208, and the retailer client API 206, respectively, in further detail and in accordance with one embodiment. The Publish Subscribe Model allows the retailer representative and the customer, respectively, to subscribe to the shared virtual shopping basket, and allows both parties to see exactly the same items in the channel of their choosing. Both parties can also publish to the shared virtual shopping basket (last publish wins) ensuring that both entities can perform CRUD actions on the shared basket in real time, as described above.

As described above, the shared virtual shopping basket 204 contains the items that are managed through the publish subscribe model 300.

The subscription includes receiving notifications relating to changes to the shared virtual shopping basket made either by the customer or by the retailer representative. The communication channels used (e.g., proprietary or third party communication channels, such as RCS, Apple Business Chat, etc.) subscribe to the shared virtual shopping basket 204, ensuring that any endpoint (i.e., retailer representative client 206 or customer client 208) shows exactly the same items.

The publishing includes making changes to the shared virtual shopping basket, either by the customer or by the retailer representative. The communication channels used (again, proprietary or third party channels) subscribe to the shared virtual shopping basket 204, ensuring that any endpoint can perform CRUD actions on the shared virtual shopping basket.

It should be noted that while the invention has been described herein by way of example of an online shared shopping basket, there are many other contexts in which it can be applied. Essentially, the invention can be used to synchronously manage a virtual area between two parties. Some examples of this include:

Retailer: Shopping for items on a website

Engineer Appointment: Managing items needed to repair an item—e.g. a car/boiler.

Beauty Appointment: Receiving advice and sharing an area of items you wish to purchase.

Home Purchase: Shared area to view and discuss properties.

Virtual Consultations: Engage with a healthcare professional and manage your prescription items.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, microservices, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be realized that while the various embodiments of the invention have been described above with respect to a single retailer representative and a single customer. However, the same principles can be extended from one-to-one interactions to either one-to-many, or many-to-many interactions between retailer representatives and customers.

Furthermore, the general principles of the invention can also be applied in other situations. For example, there may be embodiments in which a customer can visit a “virtual shopping mall” where the customer can bring his or her shopping basket to a number of different stores, and interact with retailer representatives in the individual stores. When the customer has selected all items they would like to buy, they can initiate a checkout process which either takes the customer to the individual stores' checkout processes, or initiates a single transaction in which all the retailer checks are combined and paid in a single transaction by the customer. In another embodiment, the shared virtual shopping basket can be shared between the customer a “personal shopper,” who is not a retailer representative, but rather an independent third-party agent. The personal shopper may help the customer with suggestions of online stores to visit, and then accompany the customer to the respective stores and assist the customer with selecting items, before the customer completes the checkout process. These are merely two examples of additional embodiments, and many more can be envisioned by those having ordinary skill in the art.

1. A computer-implemented method for collaborative online shopping between a customer and a retailer representative, the method comprising:
providing a communication channel between the customer and the retailer representative, through which communication channel the customer and retailer representative can have a dialog with respect to items available for purchase on a retailer website, wherein the communication channel is configurable to accommodate different communication modalities for the customer and the retailer representative;
providing a shared virtual shopping basket into which items can be added or removed in response to instructions from either the customer or the retailer representative, the shared virtual shopping basket being synchronously shared between the customer and retailer representative and synchronously viewable by the customer and the retailer representative;
in response to the customer or the retailer representative performing one or more of the following actions:
adding an item to the shared virtual shopping basket, removing an item from the shared virtual shopping basket, and changing features of an item from the shared virtual shopping basket,
synchronously updating the shared virtual shopping basket to reflect the changes that were made to the item, and notifying one or more of the customer and the retailer representative about the updates made to the shared virtual shopping basket; and
in response to the customer or retailer representative indicating that shopping is complete, transferring the contents of the shared virtual shopping basket to a shopping cart at the retailer website to complete the purchase at the retailer website.

2. The method of claim 1, wherein the communication channel is independent and agnostic from the shared virtual shopping basket.

3. The method of claim 1, wherein the communication modalities include one or more of: third party communication, video communication, voice communication, augmented reality, and virtual reality.

4. The method of claim 1, wherein the shared virtual shopping basket is implemented as a microservice and has a number of application programming interfaces allowing customers and retailer representatives to access the items in the shared virtual shopping basket.

5. The method of claim 1, wherein the communication channel is further configured to be populated with a real-time product feed showing items from the retailer's website.

6. The method of claim 1, wherein the notifying is done using a publish-subscribe mechanism relating to changes made to the shared virtual shopping basket.

7. A computer program product for collaborative online shopping between a customer and a retailer representative, the computer program product comprising a non-transitory computer readable storage medium having program code embodied therewith, the program code being executable by a processor to perform a method comprising:
providing a communication channel between the customer and the retailer representative, through which communication channel the customer and retailer representative can have a dialog with respect to items available for purchase on a retailer website, wherein the communication channel is configurable to accommodate different communication modalities for the customer and the retailer representative;
providing a shared virtual shopping basket into which items can be added or removed in response to instructions from either the customer or the retailer representative, the shared virtual shopping basket being synchronously shared between the customer and retailer representative and synchronously viewable by the customer and the retailer representative;
in response to the customer or the retailer representative performing one or more of the following actions: adding an item to the shared virtual shopping basket, removing an item from the shared virtual shopping basket, and changing features of an item from the shared virtual shopping basket,
synchronously updating the shared virtual shopping basket to reflect the changes that were made to the item, and
notifying one or more of the customer and the retailer representative about the updates made to the shared virtual shopping basket; and
in response to the customer or retailer representative indicating that shopping is complete, transferring the contents of the shared virtual shopping basket to a shopping cart at the retailer website to complete the purchase at the retailer website.

8. The computer program product of claim 7, wherein the communication channel is independent and agnostic from the shared virtual shopping basket.

9. The computer program product of claim 7, wherein the communication modalities include one or more of: third party communication, video communication, voice communication, augmented reality, and virtual reality.

10. The computer program product of claim 7, wherein the shared virtual shopping basket is implemented as a microservice and has a number of application programming interfaces allowing customers and retailer representatives to access the items in the shared virtual shopping basket.

11. The computer program product of claim 7, wherein the communication channel is further configured to be populated with a real-time product feed showing items from the retailer's web site.

12. The computer program product of claim 7, wherein the notifying is done using a publish-subscribe mechanism relating to changes made to the shared virtual shopping basket.

13. A system for collaborative online shopping between a customer and a retailer representative, comprising:
a database;
a processor; and
a memory storing instructions that when executed by the processor causes the processor to perform the following method:
providing a communication channel between the customer and the retailer representative, through which communication channel the customer and retailer representative can have a dialog with respect to items available for purchase on a retailer website, wherein the communication channel is configurable to accommodate different communication modalities for the customer and the retailer representative;
providing a shared virtual shopping basket into which items can be added or removed in response to instructions from either the customer or the retailer representative, the shared virtual shopping basket being synchronously shared between the customer and retailer representative and synchronously viewable by the customer and the retailer representative;
in response to the customer or the retailer representative performing one or more of the following actions: adding an item to the shared virtual shopping basket, removing an item from the shared virtual shopping basket, and changing features of an item from the shared virtual shopping basket,
synchronously updating the shared virtual shopping basket to reflect the changes that were made to the item, and
notifying one or more of the customer and the retailer representative about the updates made to the shared virtual shopping basket; and
in response to the customer or retailer representative indicating that shopping is complete, transferring the contents of the shared virtual shopping basket to a shopping cart at the retailer website to complete the purchase at the retailer website.

14. The system of claim 13, wherein the communication channel is independent and agnostic from the shared virtual shopping basket.

15. The system of claim 13, wherein the communication modalities include one or more of: third party communication, video communication, voice communication, augmented reality, and virtual reality.

16. The system of claim 13, wherein the shared virtual shopping basket is implemented as a microservice and has a number of application programming interfaces allowing customers and retailer representatives to access the items in the shared virtual shopping basket.

17. The system of claim 13, wherein the communication channel is further configured to be populated with a real-time product feed showing items from the retailer's website.

18. The system of claim 13, wherein the notifying is done using a publish-subscribe mechanism relating to changes made to the shared virtual shopping basket.
